(19) United States
(12) Patent Application Publication
(10) Pub. No.: US 2014/0319078 A1
(43) Pub. Date: Oct. 30, 2014

(54) PROCESS AND SYSTEM FOR REMOVING UREA FROM AN AQUEOUS SOLUTION

(71) Applicants: Luisa Kling Miller, Houston, TX (US); LUISA KLING MILLER, Trustee of the Miller Family Trust and Luisa Kling Miller Survivor's Trust, Houston, TX (US)

(72) Inventors: Luisa Kling Miller, Houston, TX (US); Jorge Miller, Houston, TX (US)

(21) Appl. No.: 14/265,299

(22) Filed: Apr. 29, 2014

Related U.S. Application Data
(60) Provisional application No. 61/817,228, filed on Apr. 29, 2013.

(51) Int. Cl. C02F 1/72; C02F 1/76

(52) U.S. Cl. CPC C02F 1/722; C02F 1/76; C02F 1/725; C02F 1/766
USPC 210/754; 210/759

(57) ABSTRACT

A process for removing urea from an aqueous solution is disclosed herein, the process comprises the steps of: feeding an aqueous solution comprising urea into a mix tank; feeding hydrogen peroxide into the mix tank; feeding at least one soluble catalyst into the mix tank separately from the hydrogen peroxide feed; mixing the aqueous solution comprising urea, hydrogen peroxide, and the at least one soluble catalyst in the mix tank, forming a reactant mixture; and oxidizing the urea in the reactant mixture yielding CO₂, N₂, and H₂O. The soluble catalyst is selected from a group of catalysts that when mixed with the hydrogen peroxide and urea causes the rate of reaction of the oxidation of the urea by hydrogen peroxide to accelerate; such as soluble iron salts. A system configured to carry out the process for removing urea from an aqueous solution is also disclosed herein. The disclosed process and system may be added to or incorporated with existing processes and systems for treating aqueous solutions.

### CROSS-REFERENCE TO RELATED APPLICATIONS

This application claims benefit of U.S. provisional patent application Ser. No. 61/817,228, filed Apr. 29, 2013, which is hereby incorporated by reference in its entirety.

### TECHNICAL FIELD

The present disclosure relates to processes and systems for removal of urea from aqueous solutions, and more specifically toward the oxidation of urea in water treatment systems.

### BACKGROUND

Urea serves an important role in the metabolism of nitrogen-containing compounds by animals and is the main nitrogen-containing substance in the urine of mammals. It is highly soluble in water and in water it is neither acidic nor alkaline. The body uses urea in many processes, the most notable one being nitrogen excretion. Urea is one of the products that is necessary to remove in the treatment of waste water.

It is known in the art to remove urea from waste water in conjunction with biological treatment by aerating the waste water and to meet the biological oxygen demand (BOD) of microbes and contemporaneously oxidizing the urea. These traditional methods known in the art comprise aerating the waste water for about 48 hours. This residence time in these traditional treatment systems may require large land area and may make it impractical to expand existing treatment systems since additional real estate may not be available.

Chlorine has been used to destroy urea. However, the use of chlorine may be expensive and may lead to the formation of chlorinated organic compounds which may be carcinogenic.

More recently, hydrogen peroxide has been used as an oxidizer. For example, hydrogen peroxide has been used to control hydrogen sulfide in sewage treatment facilities. Oxidation of urea with hydrogen peroxide yields nitrogen, carbon dioxide, and water, thus eliminating the formation of chlorinated organic compounds. However, the oxidation of urea in waste water with hydrogen peroxide may take about 30 hours for 90% oxidation, requiring large land area to treat a typical waste water plant influent.

What is needed is a more efficient process and system for removing urea from an aqueous solution.

### SUMMARY OF THE INVENTION

A process for removing urea from an aqueous solution is disclosed herein. The process comprises the steps of: feeding an aqueous solution comprising urea into a mix tank; feeding hydrogen peroxide into the mix tank; feeding at least one catalyst into the mix tank; mixing the aqueous solution comprising urea, hydrogen peroxide, and at least one catalyst in the mix tank, forming a reactant mixture; and oxidizing the urea in the reactant mixture yielding CO₂, N₂, and H₂O.

A system configured to carry out a process for removing urea from an aqueous solution is disclosed herein. The system comprises a first feeding device configured and disposed to feed an aqueous solution comprising urea into a mix tank. A second feeding device is configured and disposed to feed hydrogen peroxide into the mix tank. A third feeding device is configured and disposed to feed at least one catalyst into the mix tank. The mix tank is configured and disposed to mix the aqueous solution comprising urea, hydrogen peroxide, and at least one catalyst fed therein. A reactor is disposed to receive effluent from the mix tank and is configured to oxidize the urea.

### BRIEF DESCRIPTION OF THE DRAWINGS

FIG. 1 is an embodiment of a system for removing urea from an aqueous solution;

FIG. 2 are embodiments of reactors that may be incorporated in the system for removing urea from an aqueous solution of FIG. 1;

FIG. 3 is a sewage water treatment system having the system for removing urea from an aqueous solution of FIG. 1 disposed as a pretreatment system;

FIG. 4 is a sewage water treatment system having the system for removing urea from an aqueous solution of FIG. 1 disposed as a post-treatment system;

FIG. 5 is a water purification system having the system for removing urea from an aqueous solution of FIG. 1 disposed as a pretreatment system;

FIG. 6 is a water purification system having the system for removing urea from an aqueous solution of FIG. 1 disposed as a post-treatment system; and

FIGS. 7a-7e show examples of the process of the present disclosure and examples of the prior art.

### DETAILED DESCRIPTION

This present disclosure relates to a process and system utilizing hydrogen peroxide and one or more catalysts to chemically increase or control the oxidization rate of urea in aqueous solutions.

In the present disclosure, the rate of reaction of the oxidation of urea directly by hydrogen peroxide is advantageously accelerated preferably by the use of one or more soluble iron salts as a catalyst. This leads to an overall accelerated rate of oxidation of urea which may be the result of the accelerated rate of oxidation of urea by the hydrogen peroxide that has been accelerated by the soluble iron. Thus, the concentration of soluble iron salt used in this process may provide a way to control the overall rate of reaction of the oxidizing of urea by hydrogen peroxide.

Disclosed herein is an additional way to control the overall rate of reaction in which the soluble iron is used to accelerate the oxidation of urea by hydrogen peroxide. This additional way of controlling the oxidation rate may by the use of one or more select oxidizing agents. Oxidizing agents may be fed to the system at a concentration level that may cause the hydrogen peroxide to oxidize the oxidizing agents themselves, instead of the urea, to form intermediary oxidizing agents for oxidizing urea. The oxidation rate of urea by the intermediary oxidizing agents may occur at a lower rate of reaction than the normal rate of reaction of oxidizing urea by hydrogen peroxide. Control of the overall rate of reaction of the oxidization of urea may occur by using the one or more selected oxidizing agents with the soluble iron salt at a selected concentration. The use of the oxidizing agents and the soluble iron salt may ensure that the oxidation rate using the mixture of the oxidizing agent and the soluble salt is illustratively greater than the oxidation rate by hydrogen peroxide alone, which may have an advantageous benefit of the disclosed process and system. For example, it may be desired to fine tune the oxidation potential to use the presently disclosed process and/or system with existing processes and/or systems.

The following detailed description includes currently contemplated modes of carrying out the invention. The description is not to be taken in a limiting sense, but is made merely for the purpose of illustrating the general principles of the invention, since the scope of the invention is best defined by the appended claims. Various terms are used in the present disclosure, some may be defined elsewhere in this disclosure and some may not. If a term is defined elsewhere, then the broader definition shall be considered. Various inventive features are described below that may be used independently of one another or in combination with other features.

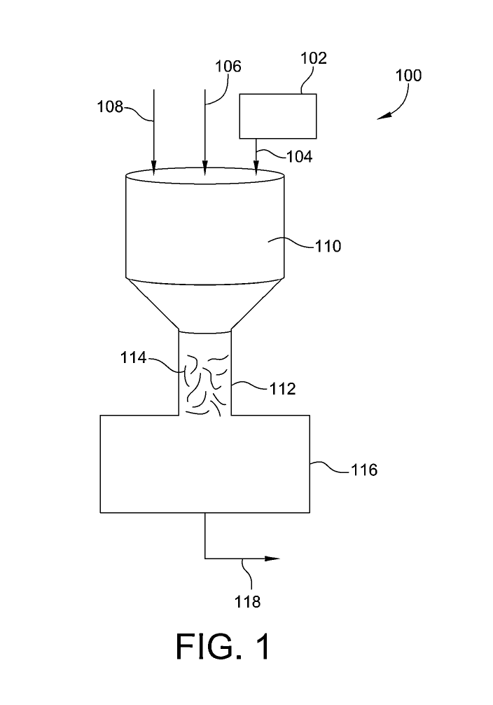

FIG. 1 shows a system for removing urea from an aqueous solution 100. A catalyst feed unit 102 may be configured and disposed to continuously feed one or more catalysts to a mix tank 110 through a catalyst feed conduit 104. The catalyst(s) being fed with catalyst feed unit 102 may be in solid or liquid form. For example, in at least one aspect of the present disclosure the catalyst(s) are in solution and catalyst feed unit 102 may be a docifier. In this aspect, the docifier may be configured to feed catalyst(s) drop-wise at a desired feed rate. However, it is to be understood that catalyst feed unit 102 may comprise any feed unit as is known in the art to feed liquids or solids. For example, in at least one aspect of the present disclosure, catalyst feed unit or device 102 may be configured and disposed to feed the at least one catalyst alone or with at least one oxidizing agent into mix tank 110. In at least one other aspect of the present disclosure, the system may further comprises a separate feeding device, not shown, configured and disposed to feed at least one oxidizing agent into the mix tank as may be preferred in an aspect where catalyst device 102 is configured to feed the at least one catalyst alone.

Hydrogen peroxide solution feed conduit 106 may be configured and disposed to continuously feed hydrogen peroxide to mix tank 110. In at least one aspect of the present disclosure, hydrogen peroxide may be fed to mix tank 110 through hydrogen peroxide solution feed conduit 106 at a desired flow rate by means as are known in the art. Aqueous urea feed conduit 108 may be configured and disposed to continuously feed an aqueous solution comprising urea to mix tank 110. Aqueous urea feed conduit 108 may be configured to receive most any aqueous solution of urea from most any source and feed to mix tank 110, at a desired flow rate. For example, aqueous urea feed conduit 108 may be configured to receive raw sewage, treated sewage, process water, and/or treated process water.

Mix tank 110 may be configured and disposed to receive catalyst(s), and optionally one or more oxidizing agents, from catalyst feed unit 102, hydrogen peroxide solution from feed conduit 106, and aqueous urea from feed conduit 108. Mix tank 110 may be configured and disposed to mix the feed materials and deliver the mixed solution to mix tank outlet conduit 112. Mix tank 110 may comprise a mixer, not shown, such as a paddle mixer or other mixer as is known in the art. Mix tank 110 may have most any configuration and volume for providing a desired mixing of the feed materials. For example, mix tank 110 may have a lower conical portion configured to feed the mixed solution to mix tank outlet conduit 112. Mix tank outlet conduit 112 may be configured and disposed to receive the mixed solution from mix tank 110 and feed the mixed solution to a reactor 116. Mix tank outlet conduit 112 may also be configured to further mix the mixed solution and/or increase contact between the catalyst(s), hydrogen peroxide, and urea in the mixed solution. For example, mix tank outlet conduit 112 may have a packing material 114 disposed therein. Packing material 114 may comprise Berl saddles, Raschig rings, Pall rings, metal Michael Bialecki rings, ceramic Intalox saddles, and/or other packing materials as are known in the art.

Reactor 116 may be configured and disposed to receive the mixed solution from mix tank outlet conduit 112 and oxidize the urea. Reactor 116 may be configured to provide a desired residence time of the mixed solution to yield a desired oxidation of the urea. For example, reactor 116 may have a volume sufficient to obtain about 90%, or more, oxidation of the urea fed into system 100. It is to be understood that the volume of reactor 116 may be based on parameters such as the volumetric flow rate of the aqueous urea solution, catalyst(s), and hydrogen peroxide through the mix tank 110 and mix tank outlet conduit 112. In one aspect of the present disclosure, reactor 116 may be omitted as a desired oxidation of the urea may be obtained in mix tank 110 and mix tank outlet conduit 112. In at least one other aspect of the present disclosure, the volume of reactor 116 is configured to provide a residence time of the reactants (aqueous urea solution, catalyst(s), and hydrogen peroxide) in system 100 in the range of about 20 to about 40 minutes, advantageously about 30 minutes. In at least one further aspect of the present disclosure, the volume of reactor 116 is configured to provide a residence time of the aqueous urea solution, catalyst(s), and hydrogen peroxide in reactor 116 in the range of about 20 to about 40 minutes, advantageously about 30 minutes. However, it is to be understood that the volume of reactor 116 may be based on additional parameters such as the rate of reaction, or rate of oxidation of urea, which in turn may vary with temperature, or other environmental conditions, as well as the constituents fed into mix tank 110.

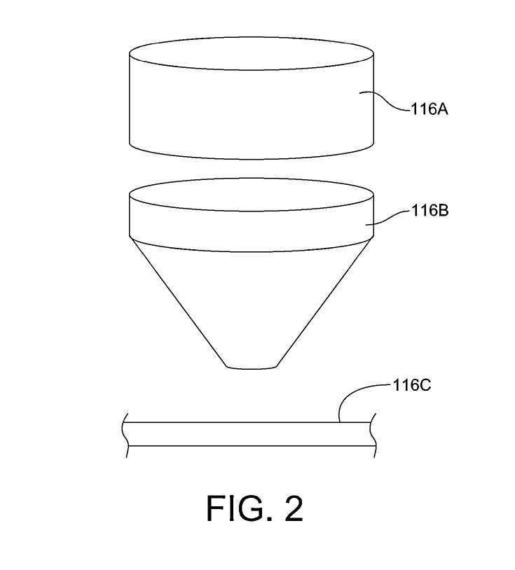

FIG. 2 shows alternative configurations of reactor 116. Reactor 116 may be a settling tank 116a. Settling tank 116a may have a means for sludge removal, not shown. For example, settling tank 116a may be equipped with a rotating arm, rakes, scrapers, or other or mechanically driven means that continually drives the collected sludge towards the center of tank 116a where it may be pumped out or otherwise removed, not shown. Reactor 116 may be a holding tank 116b configured to hold the reactants for a desired residence time. Holding tank 116b may have a means for sludge removal. For example, holding tank 116b may have a conical section and/or maybe equipped with a rotating arm, rakes, scrapers, or other or mechanically driven means that continually drives the collected sludge towards the bottom of tank 116b where it may be pumped out or otherwise removed, not shown. Reactor 116 may be a pipe 116c configured to hold the reactants for a desired residence time. Pipe 116c may have an inner-diameter and length configured to provide a desired residence time of the reactants flowing therethrough. In at least one aspect, the inner surface of pipe 116c may be rough, non-smooth, or have a contour configured to increase mixing of the reactants flowing therethrough. In at least one other aspect, the inner-diameter and inner surface of pipe 116c are configured to provide turbulent flow of the reactants therethrough. In at least one further aspect, reactor 116 may be an extension of mix tank outlet conduit 112 and may contain packing material 114.

Referring back to FIG. 1, urea removal system outlet conduit 118 is configured and disposed to provide a flowthrough outlet of the reacted constituents flowing from reactor 116. Outlet conduit 118 may be incorporated with reactor 116. For example, outlet conduit 118 may be a portion of pipe 116c (shown in FIG. 2) proximate a terminal end.

Disclosed herein also is a process for removing urea from an aqueous solution. The process may be carried out with system 100. The process may comprise feeding an aqueous solution comprising urea through aqueous urea feed conduit unit 108 and into mix tank 110. The aqueous urea feed may be a raw aqueous urea material, such as raw process water or raw sewage, or may be a treated aqueous urea solution. For example, the aqueous urea feed material may be the effluent of a sewage treatment system or other treatment system such as a water purification system, for example.

The process also may comprise feeding hydrogen peroxide into mix tank 110 through hydrogen peroxide solution feed conduit 106. The amount of hydrogen peroxide fed into mix tank 110 may be based on the amount of urea fed into mix tank 110 in the aqueous solution comprising urea. The aqueous urea solution, hydrogen peroxide, and catalyst(s) are then mixed. Oxidation of urea may commence upon mixing. For example, the oxidation of urea by hydrogen peroxide may follow the chemical reaction:

CH₄N₂O+3H₂O₂→5H₂O+CO₂+N₂ (1)

In at least one aspect of the present disclosure, a molar ratio of hydrogen peroxide to urea of about 3:1 is fed into mix tank 110. In at least one other aspect, about 1.72 grams of hydrogen peroxide are fed for each gram of urea fed into mix tank 110. In at least one more aspect, a mass ratio of hydrogen peroxide to urea of about 102:60 is fed into mix tank 110. In at least one further aspect, a molar ratio of hydrogen peroxide to urea of at least 3:1 is fed into mix tank 110 or a mass ratio of hydrogen peroxide to urea of at least 102:60 is fed into mix tank 110. For example, the step of feeding an aqueous solution comprising urea through aqueous urea feed conduit unit 108 and into mix tank 110 may comprise feeding sewage having about 1 g/L of urea. In this example, for each 1000 L of sewage fed into mix tank 110 about 1700 g of peroxide may be fed into mix tank 110.

The reaction of urea by hydrogen peroxide has a reaction constant of roughly 3.618 and the reaction is exothermic. At a temperature of 20 degrees C., about 219.093 kilo-calories of heat is generated, causing the breakdown of urea and hydrogen peroxide to form water, carbon dioxide and nitrogen according to the reaction. The time of reaction for the breakdown of urea and hydrogen peroxide to form water, carbon dioxide and nitrogen may be about 30 hours based upon the time of reaction for oxidizing urea by hydrogen peroxide.

In the present disclosure, the rate of reaction of the oxidation of urea directly by hydrogen peroxide is advantageously accelerated preferably by the use of a soluble catalyst. This may lead to an overall accelerated rate of oxidation of urea resulting from the accelerated rate of oxidation of urea by the hydrogen peroxide that has been accelerated by the soluble catalyst.

Advantageously, the soluble catalyst that is added to the aqueous solution of hydrogen peroxide and urea is generally not part of the reaction that takes place between the hydrogen peroxide and the urea in the aqueous solution. Rather, the presence of the soluble catalyst in the solution generally serves merely to change the rate of that reaction. Hence, the catalyst may stay in the solution throughout the process. The catalyst may be introduced into the solution as a soluble catalyst and once contacting the water in the solution may hydrolize, if in the ferric form, into a hydroxide, such as ferric hydroxide, which may be a suspension. If in ferrous form, the hydrogen peroxide may oxidize it to ferric hydroxide which may be suspended in the water. In other words, even as more and more hydrogen peroxide is reacted out of the aqueous solution by its reaction with the urea to form other products, the catalyst may remain constant throughout the process.

This overall rate may be tuned by feeding an amount of a predetermined oxidizing agent to redirect the oxidation potential of hydrogen peroxide. This may be because when hydrogen peroxide is in the presence of both the oxidizing agent and the urea, the potential for oxidizing the oxidizing agent is lower than the potential for oxidizing the urea. Thus, the hydrogen peroxide may choose the path of oxidizing the oxidizing agent instead of oxidizing the urea. This may lower the overall rate of the oxidation of urea.

In at least one aspect, the soluble catalyst useful in various embodiments of the disclosed system and process may be a non-toxic soluble iron salt such as may be defined by the Centers for Disease Control and Prevention (CDC) and other institutions of repute. The use of non-toxic soluble iron salts with the presently disclosed system or process may be advantageous in providing, or incorporating with existing systems, processes or systems where it is desirable to reduce the concentration of urea.

The soluble iron salt may be selected from the group consisting of soluble irons, including most preferably FeSO₄: ferrous sulfate; FeCl₂: Ferrous chloride; Fe(NO₃)₃: Ferric nitrate; Fe(SO₄)₃: Ferric sulfate; FeCl₃: Ferric chloride; Ferrous gluconate: C₁₂H₂₂FeO₁₄; and other Ferrous organic or inorganic salts. Advantageously, the soluble catalyst may be soluble in water or may become soluble in water with slight heating. All combinations and subcombinations of such soluble irons are included and disclosed herein. For example, the soluble iron may comprise only a single soluble iron. For example, the soluble iron may comprise ferric sulfate with no other soluble iron; or in the alternative, the soluble iron may comprise ferric chloride with no other soluble iron; or in the alternative the soluble iron may comprise ferric nitrate with no other soluble iron component. In the alternative, the soluble iron may comprise a mixture of soluble irons. For example, a mixture of soluble irons may comprise ferric sulfate and ferric chloride.

Illustratively, a soluble iron salt, or mixture of soluble iron salts, used for the soluble catalyst may have a concentration of about 2 PPM to about 20 PPM and preferably about 10 PPM. As one example, a soluble iron salt used for the soluble catalyst may have a concentration of about 10 PPM in a reactant mixture. The oxidation of urea by hydrogen peroxide accelerated by the inclusion of ferrous sulfate at this concentration of about 10 PPM may reduce the period of time required for oxidation of urea to about or under 30 minutes from about 30 hours, as may be realized with existing oxidation systems and/or processes.

The concentration of soluble catalyst used in this process may provide a way to control the overall rate of reaction of the oxidizing of urea by hydrogen peroxide. For example, a higher concentration of soluble iron salt(s) may cause more of the hydrogen peroxide to oxidize urea at rate of reaction that is more accelerated. A lower concentration of soluble iron salt may cause the hydrogen peroxide to oxidize urea at a rate of reaction that is accelerated but at a lower rate than the acceleration of the urea by a catalyst at a higher concentration. Another or additional way to control the overall rate of reaction in which the soluble iron is used to accelerate the oxidation of urea by hydrogen peroxide may be with the use of one or more selected oxidizing agents at a concentration level that causes the oxidation potential of hydrogen peroxide to oxidize the oxidizing agents themselves, instead of the urea, and form intermediary oxidizing agents. The oxidation rate of urea by the intermediary oxidizing agents may occur at a lower rate of reaction than the normal rate of reaction of oxidizing urea by hydrogen peroxide. Thus, the addition of the oxidizing agents to the aqueous solution containing hydrogen peroxide and urea may cause the overall rate of oxidation of urea to slow down; hence “tuning” the overall oxidation rate which is being accelerated by the addition of the catalyst. A balance between the concentrations of the oxidizing agent and the catalyst that are added to the aqueous solution containing the hydrogen peroxide and urea thus provides a mechanism for controlling the acceleration of hydrogen peroxide by the catalyst.

As evident from the foregoing description, by feeding an amount of a predetermined oxidizing agent which will compete with the hydrogen peroxide to oxidize the urea, the overall rate of oxidation of urea may thus be tuned or controlled. The oxidizing agents “tune” the overall oxidation reaction by causing the overall rate of oxidation of urea by hydrogen peroxide to slow down which is otherwise being accelerated by the addition of the catalyst.

Control of the overall rate of reaction of the oxidization of urea may occur by using the one or more select oxidizing agents with the soluble iron salt in a concentration. As previously described, the soluble catalyst increases the rate of oxidation of the hydrogen peroxide. Without the oxidizing agent, that accelerate reaction rate may be targeted toward the oxidation of urea. With the agent, the target of the oxidation may become the agent to form intermediary oxidation of the urea at a rate that is slower than the direct oxidation of urea by hydrogen peroxide. By balancing the rate of acceleration of oxidation of the hydrogen peroxide by the catalyst against the deceleration of that hydrogen peroxide by the oxidizing agent, the overall rate of reaction of the urea may be controlled.

In at least one aspect, the oxidizing agents useful for inclusion with the soluble iron salt, or other catalyst, in controlling the overall rate of oxidization in which the rate of reaction of the oxidation of urea by hydrogen peroxide has been accelerated by a soluble catalyst, such as soluble iron salt, in various embodiments of the disclosed system and process, is a soluble oxidizing agent which comprises one or more of sodium chloride, potassium iodine, potassium bromide, and manganese. The soluble catalyst such as soluble iron salt may be used with one or more of these or other oxidizing agents. For example, one mixture of catalyst and oxidizing agent may be a mixture comprising a catalyst ferrous sulfate at a concentration of 10 PPM mixed with 10 PPM sodium chloride, 10 PPM potassium iodine, 10 PPM potassium bromide, and 10 PPM manganese. Using this mix of soluble iron salt and oxidizing agent, it was found that the period of time required for oxidation of urea may be reduced to about 30 minutes from about 30 hours, as compared to oxidizing urea with hydrogen peroxide alone.

As seen from this disclosure, the soluble catalyst such as soluble iron salt may be used to accelerate the rate of reaction of the oxidizing of urea by hydrogen peroxide and hence the overall rate of oxidation of urea. The overall rate of oxidation of urea may be controlled by the concentration of the soluble catalyst such as soluble iron salt. As also seen from this disclosure, the overall reaction rate of reaction of the oxidation of urea by the soluble iron may be further controlled by including one or more of the oxidizing agents described above with the soluble catalyst, such as soluble iron salt. These oxidizing agents may serve to advantageously decelerate the overall process of oxidizing urea as described above.

By introducing one or more intermediary steps in the process of oxidization of urea and that occur at a lower rate of reaction than the rate of reaction of hydrogen peroxide alone, or accelerated by the soluble catalyst such as iron, the oxidizing agents may serve to decelerate the overall urea oxidizing process. This is apparent when considering that the overall rate of reaction in the case of a process to oxidize urea in which an oxidizing agent is added with a soluble catalyst, such as soluble iron, to the hydrogen peroxide and urea is effectively the result of the sum of (1) and (2); wherein (1) is the rate of reaction of the hydrogen peroxide that oxidizes urea at a rate of reaction that has been accelerated by the soluble iron salt and hence accelerates the overall oxidation of urea; and (2) is the slowing down of this accelerated rate of reaction of the hydrogen peroxide by the oxidizing agents to produce intermediary oxidizing agents that are oxidizing urea at a rate of reaction that is lower than the rate of reaction of hydrogen peroxide alone. The first reaction, (1), accelerates the overall oxidation of urea, and the second reaction, (2), decelerates the overall oxidation of urea. Hence, the first and second reactions may be used to control the overall rate of reaction. By balancing the first and second reactions against each other, the overall oxidation rate of urea may be controlled. Illustratively, the balance may be tipped in favor of the first reaction in order to ensure that the overall rate of reaction is faster than the rate of reaction of hydrogen peroxide and urea alone; otherwise the process of oxidizing urea using soluble iron as a catalyst may be outweighed by just using hydrogen peroxide alone in the process to oxidize the urea.

There is thus disclosed a method to accelerate the oxidation of urea by hydrogen peroxide by the use of a soluble catalyst such as soluble iron. There is also disclosed a method to control that acceleration by the concentration of the soluble catalyst added to the hydrogen peroxide and urea solution. There is also disclosed a method to control the overall rate of reaction of the oxidization of urea by the use of the one or more select oxidizing agents with the soluble iron salt in a concentration that may ensure that the oxidation potential obtainable from the hydrogen peroxide that has been accelerated in rate of reaction by the soluble iron salt outweighs the oxidation potential obtainable by the intermediary oxidizing agents. In this way, the overall potential for oxidizing urea may remain greater than the oxidation potential by hydrogen peroxide alone which may provide an advantageous benefit of the disclosed process and system.

An example catalyst for mixing with urea and hydrogen peroxide comprises ferrous sulfate at a concentration of 10 PPM, 10 PPM sodium chloride, 10 PPM potassium iodine, 10 PPM potassium bromide, and 10 PPM manganese in a reactant mixture. This example catalyst may provide a particular strong accelerator to the reaction of the urea and hydrogen peroxide; yielding a breakdown of the urea to water, carbon dioxide, and nitrogen in about 30 minutes. However, this period of time may be increased if the concentration of the ferrous sulfate is decreased and/or the concentrations of the oxidizing agents is increased in this example. In addition, this period of time may be decreased if the concentration of the ferrous sulfate is increased and/or the concentrations of the oxidizing agents is decreased in this example. In these examples, the particular increases and/or decreases in the ferrous sulfate and/or the oxidizing agents are to be made in accordance with this disclosure which may ensure that the oxidation potential obtainable from the hydrogen peroxide, accelerated in rate of reaction by the soluble iron outweighs the oxidation potential obtainable by the intermediary oxidizing agents obtained from the oxidizing agents. In this way, the overall oxidizing rate may remain better than is obtainable from using hydrogen peroxide alone, which may provide an advantageous benefit of the disclosed process and system. While use of this balanced control of catalyst and oxidizing agent to yield a rate of reaction that is better than the rate of reaction obtainable by the use of hydrogen peroxide by itself, the controlled balance of this disclosure may also be used to produce a rate of reaction that may be lower. It is the control of the overall reaction that may be made possible by the controlled acceleration of the hydrogen peroxide oxidation that may provide one of the advantages of the disclosed process and system.

In addition, this period of time may be decreased if only 10 PPM ferrous sulfate is added to the hydrogen peroxide and aqueous urea (i.e., no oxidizing agent is used in this example). This may be because that without the oxidizing agents to decelerate the overall oxidizing rate of the urea, the oxidation of urea may occur by the oxidation rate of urea by hydrogen peroxide accelerated by the soluble iron salt. If the concentration of ferrous sulfate added to the hydrogen peroxide and aqueous urea is greater or less than 10 PPM, then the overall oxidation reaction of urea by hydrogen peroxide may be accelerated accordingly.

The 30 minute period of time previously discussed is one that is chosen based on the use of the disclosed process and system with conventional equipment. However, this period of time may be shortened or lengthened based upon the size and configuration of the reactor disposed to receive effluent from the mix tank and configured to oxidize the urea. The specific period of time for oxidizing the urea may be chosen according to this disclosure.

The 30 minute (or other shortened or lengthened) period of time of the overall reaction to oxidize urea may be a significant improvement over the typical time required to breakdown urea to water, carbon dioxide, and nitrogen, which is previously described, which may take about 30 hours. Hence, the soluble catalyst, alone or with oxidizing agents, may provide a substantial increase and/or control in the oxidation rate of urea with hydrogen peroxide.

The at least one catalyst may be fed at a rate sufficient to provide a desired increase in the oxidation rate or urea, for example the one or more catalyst may be fed at a rate to provide about a 10 ppm concentration of the at least one catalyst in mix tank 110. The catalyst(s) may be solid or in solution. In at least one aspect of the present disclosure, the catalysts are liquid or in solution and the step of feeding at least one catalyst into the mix tank comprises feeding at least one catalyst into the mix tank drop-wise with a docifier. One or more oxidizing agents may also be fed to mix tank 110 with catalyst(s)

The process further comprises mixing the aqueous solution comprising urea, hydrogen peroxide, at least one catalyst, and optionally at least one oxidizing agent, forming a reactant mixture. Mixing may be carried out in mix tank 110. The process may further comprise flowing the reactant mixture through a packed column. For example, the process may comprise a step of flowing the reactant mixture through at least one of Berl saddles, Raschig rings, Pall rings, metal Michael Bialecki rings, and ceramic Intalox saddles.

A final step of oxidizing the urea in the reactant mixture yields CO₂, N₂, and H₂O. The step of oxidizing the urea in the reactant mixture may be performed for up to about 30 minutes, up to about an hour, or between 15 minutes and two hours, for example. Additionally or alternatively, the step of oxidizing the urea in the reactant mixture may comprise oxidizing at least about 90% of the urea in the reactant mixture or urea in the aqueous solution comprising urea fed into mix tank 110. The step of oxidizing the urea in the reactant mixture may be primarily performed in a reactor, such as reactor 116, 116a, 116b, or 116c. However, it is to be understood that the step of oxidizing the urea in the reactant mixture may be primarily performed in mix tank 110 and/or mix tank outlet conduit 112, and/or other stations or components of the system for removing urea from an aqueous solution.

It is to be understood that the disclosed process for removing urea from an aqueous solution is disclosed with reference to system 100 for clarity only and that the process may be carried out in other and different systems. For example, the process may be incorporated with existing systems designed to carry out different treatment processes.

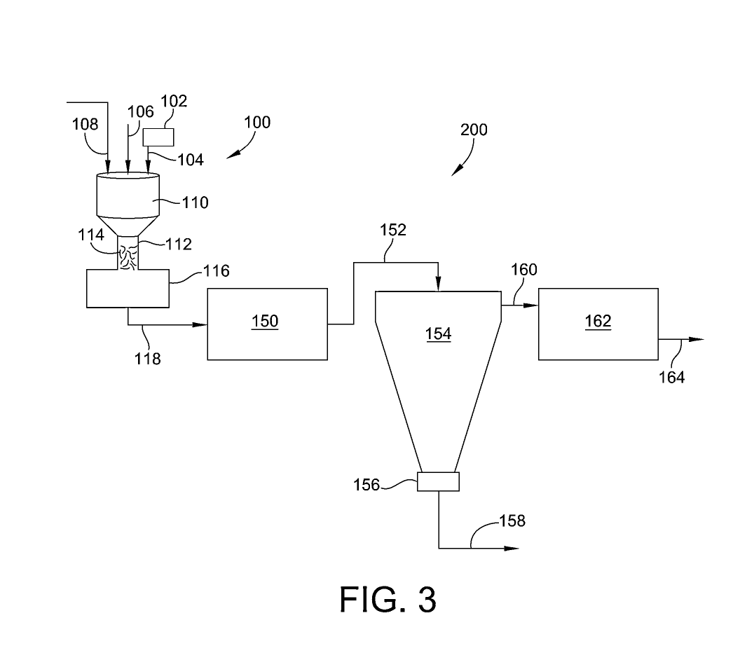

It is to be understood the system 100 for removing urea from an aqueous solution and the disclosed process for removing urea from an aqueous solution may be a standalone system or may be incorporated with existing treatment systems. For example, FIG. 3 shows sewage water treatment plant 200 having a pretreatment system 100 configured and disposed for removing urea from sewage. In this example, aqueous urea feed conduit 108 is configured to provide sewage and feed sewage to mix tank 110. System 100 is configured and disposed to oxidize urea in the sewage fed to system 100 through feed conduit 108 and to feed air oxidation system 150 through urea removal system outlet conduit 118.

Air oxidation system 150 may be configured to hold the effluent from system 100 and wherein it may be aerated to satisfy the biological oxygen demand (BOD) of microbes breaking down fecal material therein. Further urea oxidation may take place in oxidation system 150. Therefore, system 100 may have a residence time less than 30 minutes, and/or the oxidation of urea in system 100 may be less than 90%. For example, the residence time of the aqueous urea in system 100 may be as little as 15 minutes and/or the oxidation of urea in system 100 may be about 50%. The effluent from air oxidation system 150 is fed through settling tank feed conduit 152 to settling tank 154. Settling tank 154 may be conical and/or be equipped with a rotating arm, rakes, scrapers, or other or mechanically driven means that continually drives the collected sludge towards the center of settling tank 154 where it may be pumped out with pump 156 or otherwise removed through settling tank outlet conduit 158. The effluent from settling tank 154 may be fed through chlorination tank feed conduit 160 to chlorination tank 162. Chlorination tank 162 may be configured to chlorinate the treated solution flowing thereto, through chlorination tank feed conduit 160, and kill microbes prior to releasing the treated water to the environment, through chlorination tank outlet conduit 164. Advantageously, oxidation of urea by the disclosed process upstream of the air oxidation system 150 may remove some or substantial amounts of urea from the sewer water so that more of the oxidation potential available in oxidation system 150 is available for breaking down the fecal matter in the sewer water since less oxidation is expended in removing any remaining urea in the sewage water.

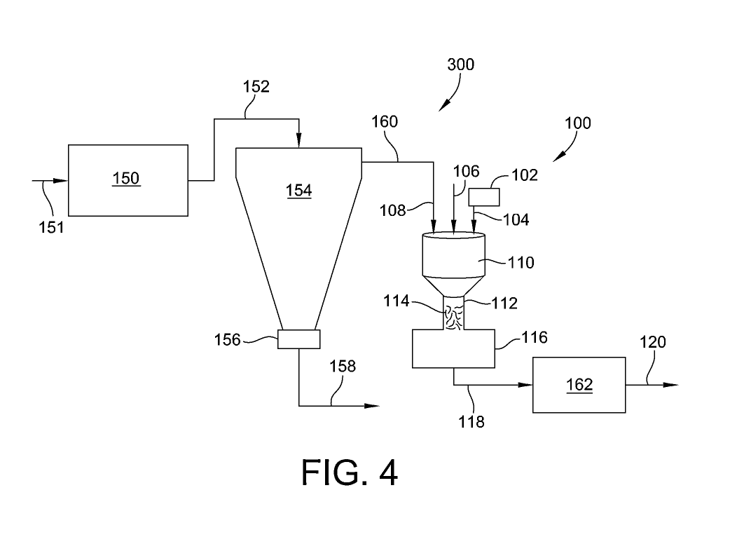

In another example, FIG. 4 shows sewage water treatment plant 300 having a post-treatment system 100 configured and disposed for removing urea from the effluent of water treatment plant such as a waste water treatment plant. In this example, sewage feed conduit 151 is configured and disposed to feed sewage to air oxidation system 150. The effluent from air oxidation system 150 is fed through settling tank feed conduit 152 to settling tank 154. The configuration of the settling tank 154 and manner of operation are as previously described. Aqueous urea feed conduit 108 is configured and disposed to feed the effluent from settling tank 154 to mix tank 110. Urea removal system outlet conduit 118 may be configured and disposed to feed chlorination tank 162 with the effluent from reactor 116. Chlorination tank outlet conduit 120 may be configured and disposed to discharge the effluent from sewage water treatment plant 300 to the environment. In this example, a percentage of the urea fed through sewage feed conduit 151 may be oxidized in air oxidation system 150 and/or settling tank 154. Consequently, the residence time of the flow-through materials may be about 30 minutes or less, to enable water sewage water treatment plant 300 to oxidize a desired percentage of urea.

It is to be understood that system 100 for removing urea from an aqueous solution may be incorporated at various points in known treatment systems. For example, system 100 may be incorporated in a sewage water treatment plant between air oxidation system 150 and settling tank 154. Additionally, system 100 may be incorporated with known treatment systems with few structural additions or modifications. For example, settling tank 154 may incorporate the functions of mix tank 110, mix tank outlet conduit 112, and/or reactor 116. Such an incorporation may substantially reduce or even eliminate a need for additional processing equipment to existing systems. For example, hydrogen peroxide solution feed conduit 106 and catalyst feed conduit 104 may be configured and disposed to feed settling tank 154 and urea removal system outlet conduit 118 may be configured and disposed to feed chlorination tank 162 with the effluent from settling tank 154.

Traditional waste or sewage water treatment systems typically have an air oxidation system 150, a settling tank 154, and a chlorination tank 162. The urea in the feed stream or sewage is typically oxidized by air oxidation system 150 contemporaneously with microbial decomposition. In this respect, it may take about 48 hours to obtain a desired urea decomposition in a typical air oxidation system. This long residence time in air oxidation system 150 may cause the volume of air oxidation system 150 to be quite large and consequently require much land area. Incorporation of the process disclosed herein, or system 100, for removing urea from an aqueous solution with these traditional waste or sewage water treatment systems may substantially reduce the residence time in air oxidation system 150. Reduction of the residence time in air oxidation system 150 may enable the volume of air oxidation system 150 to be reduced and consequently require less land area. For example, incorporation of system 100 with traditional waste or sewage water treatment systems may reduce the required residence time of air oxidation system 150 by up to about ⅓ or even ½. Therefore, the capacity of a traditional sewage water treatment system may be substantially increased, or even doubled, with the incorporation of the presently disclosed process or system 100 without the need of additional real estate. The increased capacity may be realized with increased throughput of sewage through the sewage water treatment plant incorporating the presently disclosed process or system 100.

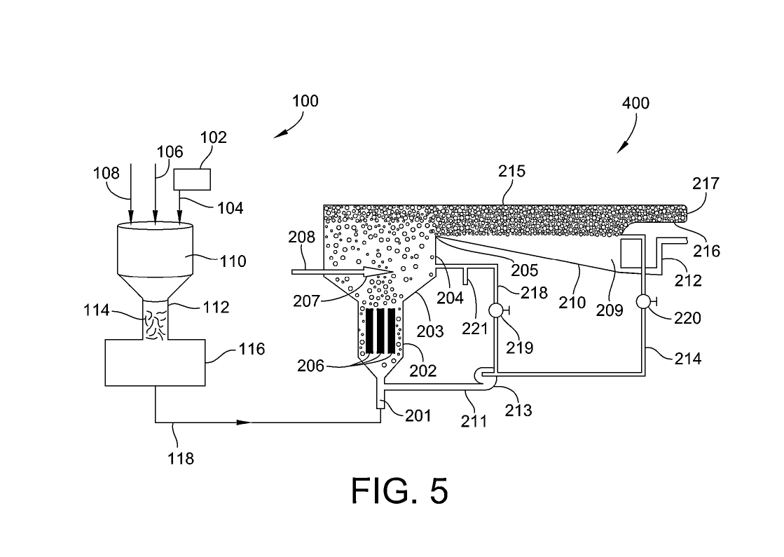

FIG. 5 shows another example of the incorporation of system 100 for removing urea from an aqueous solution with another treatment system. FIG. 5 shows a water purification system 400 having a pretreatment system 100 for removing urea. Water purification system 400 may comprise a purification system such as the water purification system disclosed in U.S. patent application Ser. No. 12/859,041, by Miller et al, filed Aug. 18, 2010, incorporated herein by reference. For example, system 100 may be disposed to pre-treat water to be processed or treated with water purification system 400 by oxidizing the urea in a feed stream being fed into mix tank 110 through aqueous urea feed conduit 108.

The effluent from system 100 may comprise a pre-treated aqueous solution, having a portion of its urea oxidized, and may be fed through urea removal system outlet conduit 118 to inlet conduit 201 of the water purification system 400. Inlet conduit 201 may be connected to the bottom of an electrolytic cell 202. At the top of the electrolytic cell 202 is an upper section 204 having an outlet passage 205. The upper section 204 preferably includes a conical section 203 connected to the top of the electrolytic cell 202 and an outlet conduit 218. The outlet passage 205 is located above the conical section 203. Between the outlet passage 205 and the conical section 203, the outlet conduit 218 exits the upper section.

Outlet conduit 218 includes line 221 and is fed to the inlet of a re-circulating pump 213. Air and additional soap may be introduced through line 221 into the system. The upper section 204 is preferably closed to the atmosphere. Electrodes 206 are mounted in cell 2 in any suitable way (not shown in the drawing) and are connected in series to a direct current source which is changed in polarity continuously. In some embodiments of the invention, an air sparger 207 may be located at the top of the conical section 203, above the point where the solid particles have settled, but still below the surface level of fluid. By “sparger” herein what is meant that an air blower is positioned below fluid level, so as to blow bubbles through the fluid. The air sparger 207 supplies additional bubbles besides those formed during electrolysis to the upper section 204. The air sparger 207 may be connected to a compressed air supply 208. The compressed air produces bubbles to float the flocs produced by the release of metallic soaps during the electrolysis of the water to be purified. In some embodiments, the air bubbles are introduced after the electrolytic cell, but below the surface level of the fluid (e.g., below the outlet passage 205).

Outlet passage 205 is connected to basin 209. Basin 209 also includes a draining space 215 that may have an inclined bottom 210. A recirculating conduit 211 is near the upper edge of the basin and preferably opposite from the outlet passage 205. The basin 209 is preferably closed to the atmosphere. A purified water outlet 212 is at the bottom of basin 209, also preferably opposite from the outlet passage 205. A suds outlet 216 is located opposite the outlet passage 205, preferably some distance away to allow acceptable separation of the floc and the purified water. Recirculating conduit 211, along with outlet conduit 218, is fed to re-circulating pump 213 whose outlet 214 may be connected to the inlet conduit 201 below the electrolytic cell 202.

Basin 209 also includes a suds outlet 216 which is located above the draining space 215. The location of the recirculating conduit 211 is preferably located near or below the layer of bubbles in order to catch any settling floc and recycling it to the electrolytic cell. This insures that all floc preferably exits through the suds outlet 216. Water containing flocs and bubbles is led through passage 205 to basin 209 and the draining space 215. Purified water leaves via purified water outlet 212 which is preferably at a level below that of the suds layer during operation. Recirculating conduit 211 and conduit 218 leads recirculating water with flocs through pump 213 and conduit 214 to intake conduit 211. Conduit 218 recirculates the upper layer of water in the conical section of the electrolytic cell through the electrodes. Some embodiments may include valve 219 and valve 220 which may be used to control the re-circulation ratio. Soap solution and additional air is supplied to water outlet conduit 211 through line 221.

In water purification system 400 having system 100 disposed as a pretreatment system for removing urea from a feed stream to a purification system, shown in FIG. 5, the purification system may receive an influent, through inlet conduit 201, having a substantial portion of its urea oxidized. Oxidation of the urea fed to system 400, through aqueous urea feed conduit 108, may provide for the purification of water wherein the purified water has most solids removed therefrom and most of its urea oxidized prior to exiting system 400 through purified water outlet conduit 212.

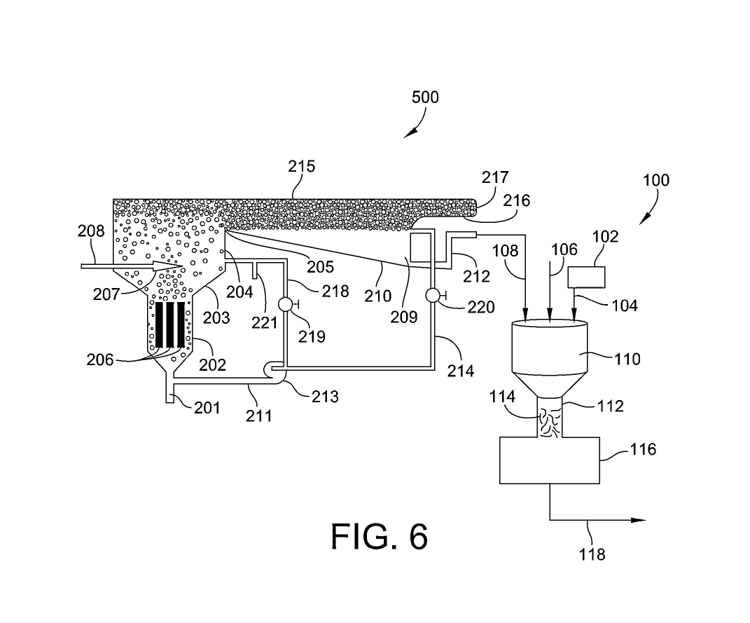

FIG. 6 shows another example of the incorporation of system 100 with other aqueous treatment systems. For example, water purification system 500 has system 100 disposed as a post-treatment system for removing urea from an aqueous solution. In this example, aqueous urea feed conduit 108 is configured and disposed to be fed with purified water outlet conduit 212. The purified water fed into mix tank 110 through aqueous urea feed conduit 108 is substantially free of solids. This may have a positive effect on the performance of system 100 in removing urea from an aqueous solution.

Additionally, in one aspect of the present disclosure, the process for removing urea from an aqueous solution or system 100 may be incorporated within the water purification system disclosed in U.S. patent application Ser. No. 12/859,041 with few additions or modifications. For example, basin 209 may be used to provide the functions of mix tank 110, mix tank outlet conduit 112, and/or reactor 116; hence replacing the need for a separate mix tank 110, mix tank outlet conduit 112, and/or reactor 116 in this incorporated example. Such an incorporation may substantially reduce or even eliminate a need for additional processing equipment with the water purification system. For example, hydrogen peroxide solution feed conduit 106 and catalyst feed conduit 104 may be configured and disposed to feed the water that lies beneath the surface of the floc in basin 209 resulting in purified water outlet conduit 212 having treated water with a substantial portion of its urea oxidized.

Water purification systems 400 and 500, shown in FIGS. 5 and 6 may provide for a water purification process comprising the following steps; (a) passing contaminated water in a generally vertically upward direction through an electrolytic cell having a plurality of electrodes surrounded by a moving bed of solid, non-conductive particles to form a hydrophobic floc comprising purified water, water, impurities and suds; (b) directing the floc to a closed chamber directly connected to an upper end of the electrolysis chamber; (c) separating the impurities, suds and water from the purified water; (d) recirculating a portion of the water from the closed chamber to the electrolytic cell; (e) removing the impurities and suds from the closed chamber, and (f) removing the purified water from the closed chamber.

In some embodiments, air is sparged above the electrolytic cell, but below fluid level, and the electrodes are connected in series with the polarity of the electrodes being changed continuously. In some embodiments, the upward velocity of the water is partially accomplished by re-circulating the water through the cell and the contaminated water is directed through the moving bed by pressure. The non-conductive particles are preferably granite and have a specific density greater than that of the contaminated water and their free falling velocity is greater than the upward velocity of the water. In some embodiments, the purified water is further chlorinated. In some embodiments, the polarity of the electrodes is being alternated by applying a direct current voltage and the frequency in change of polarity ranges from about 1 change per second to about 1 change per 10 minutes and the change of polarity has the same duration. In some embodiments, additional soap solution is added to the water to be purified and micro bubbles are produced utilizing the change in pressure due to a re-circulation pump.

The examples shown in FIGS. 3-6 are not to limit the application of the process for removing urea from an aqueous solution or system 100 for removing urea from an aqueous solution, but instead disclose only a few of potential applications. As will become apparent by persons having ordinary skill in the art upon reading the present disclosure, there are many more and different applications of the process for removing urea from an aqueous solution and system 100 presently disclosed.

### Example

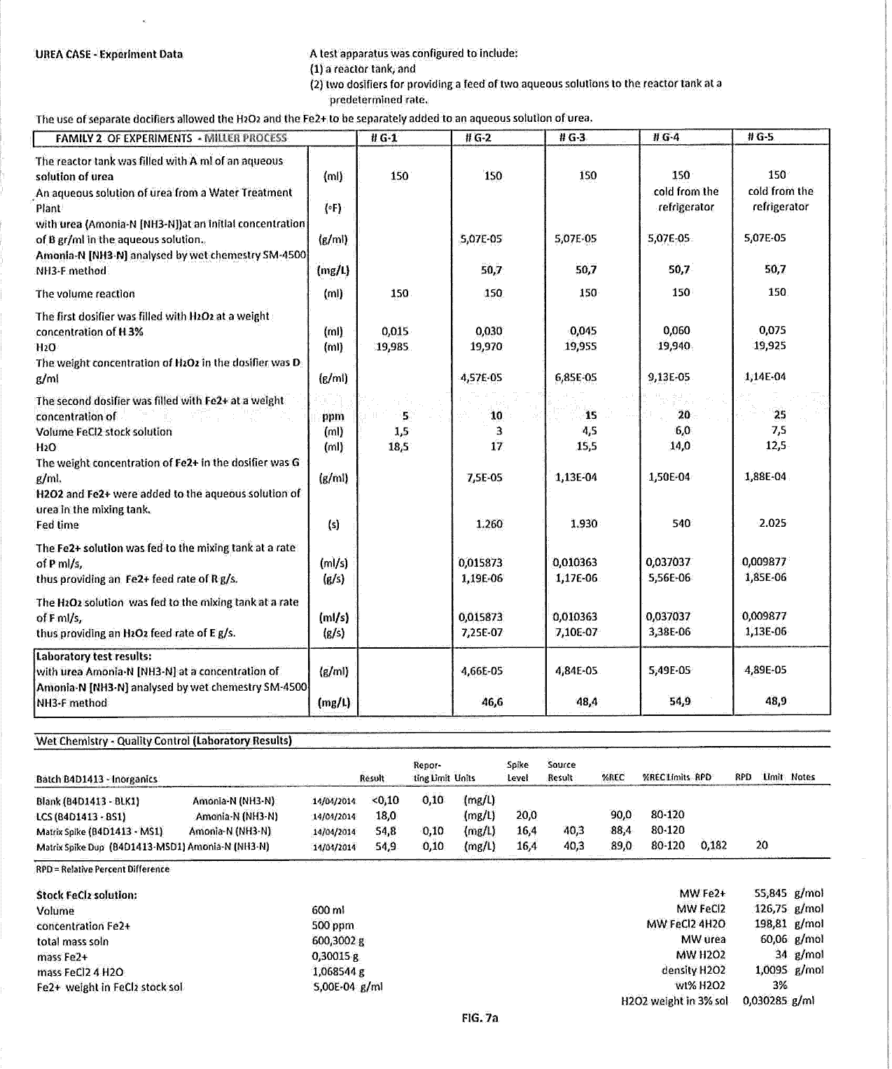

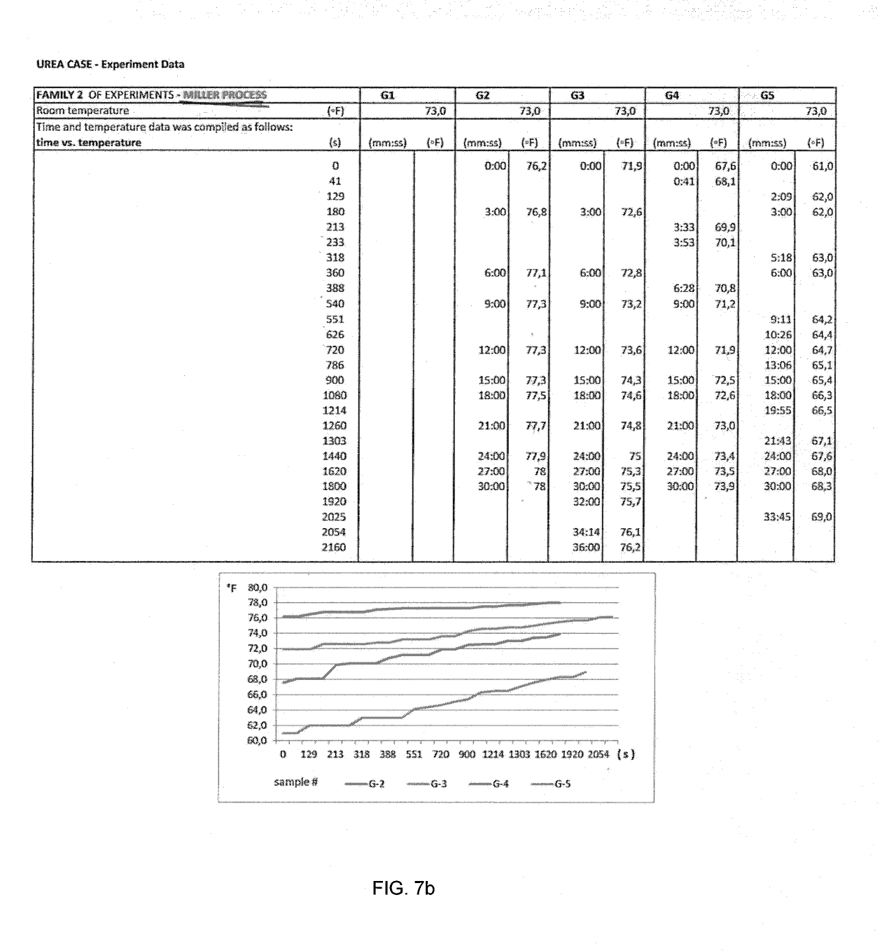

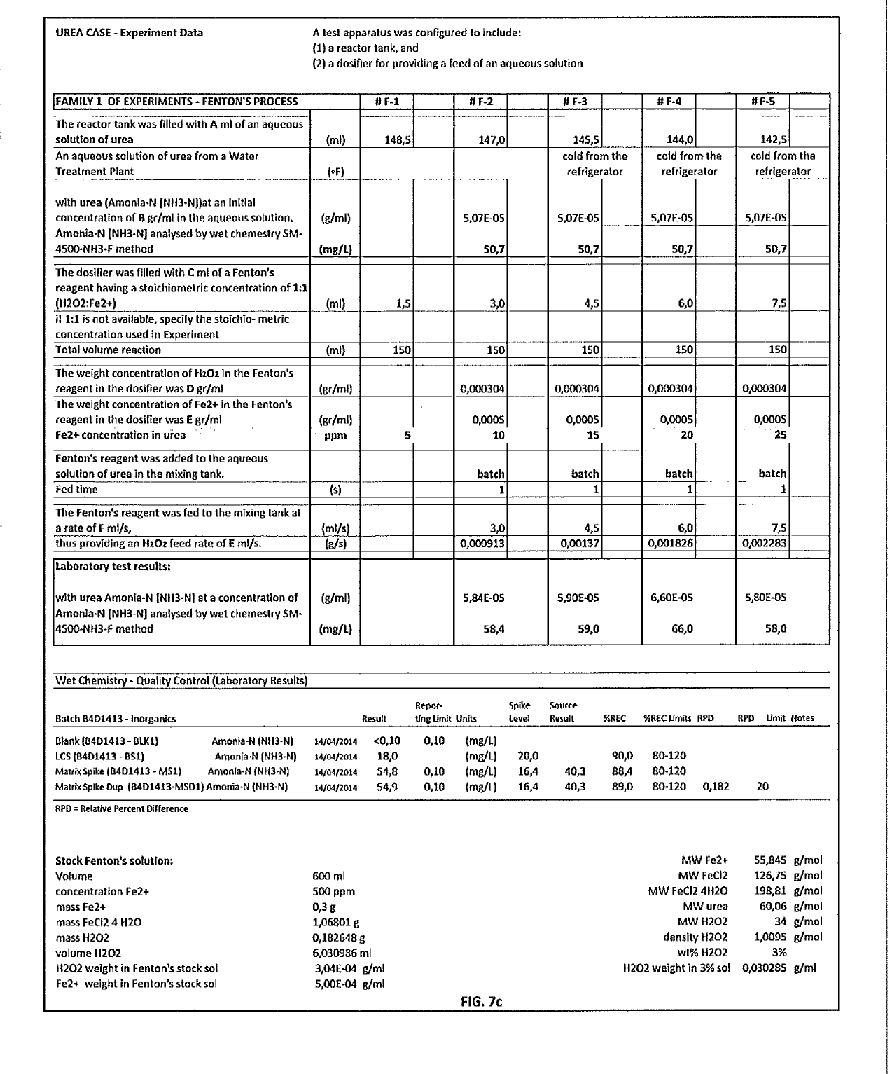

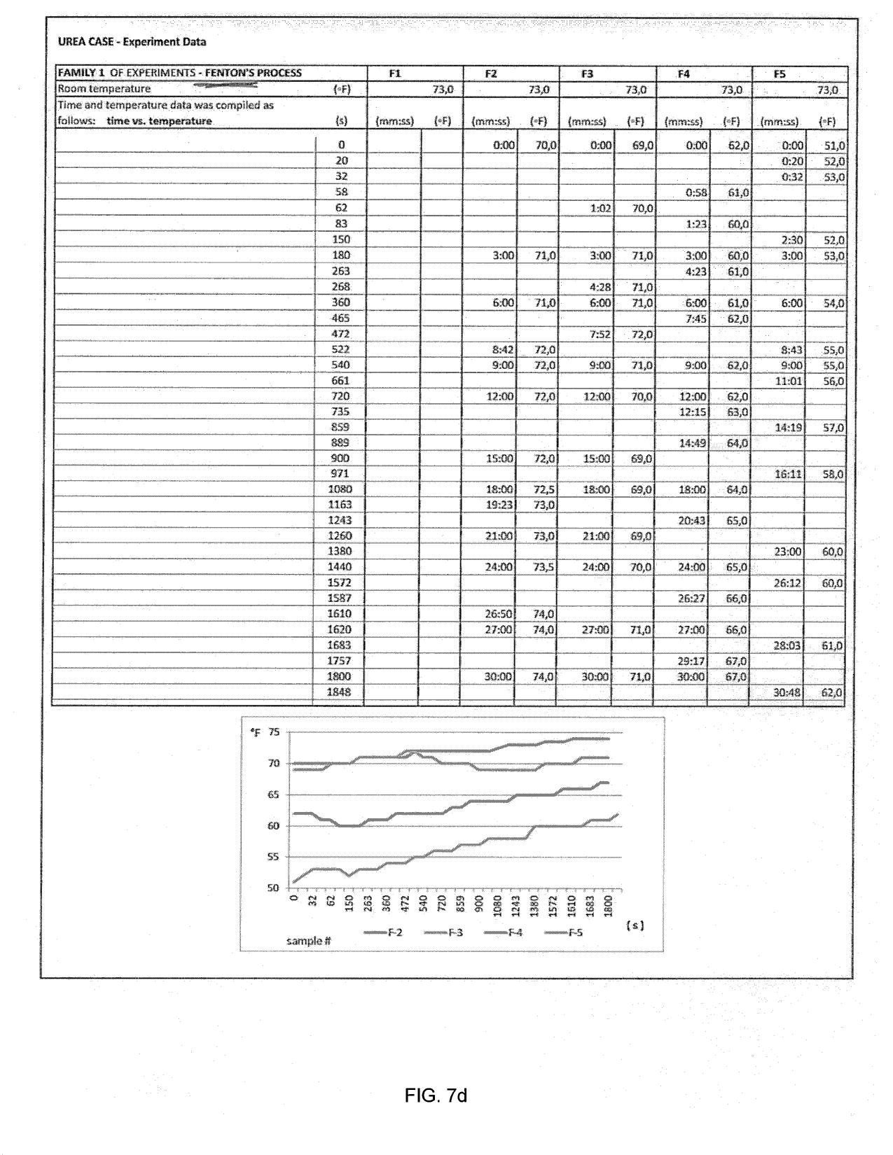

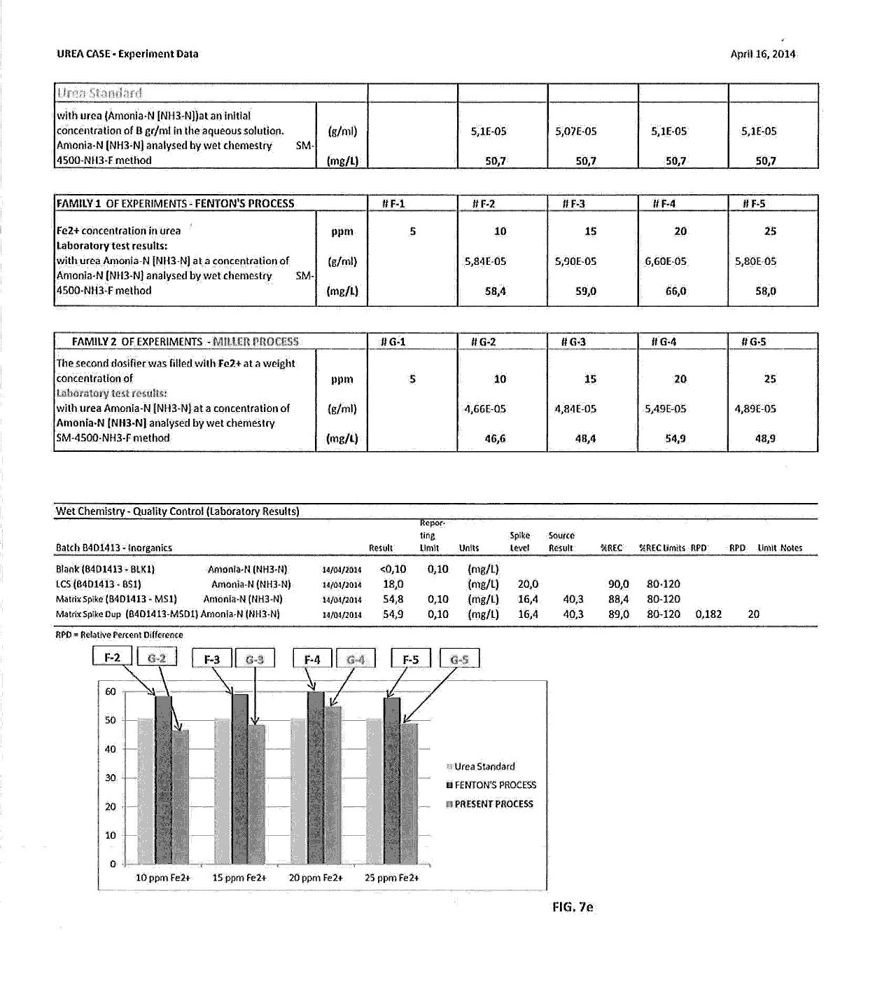

FIGS. 7a-7e show examples of the process of the present disclosure and examples of the prior art. Test runs G-4, F-4 were redone on account of an erroneous test setup observed in these test runs In examples G-2 through G-5 of the process of the present disclosure, urea, H₂O₂, and Fe²⁺ were separately fed to a continuously stirred beaker. The feed rate of the of the Fe²⁺ was about 1.6 grams per second for each gram per second of the H₂O₂ being fed. Advantageously, the separately feed of at least one soluble catalyst is fed at a rate between about 1 to 2 grams per second for each gram per second of the hydrogen peroxide being fed into a mix tank. In examples F-2 through F-5 of the process of the prior art, a Fenton's reagent comprising H₂O₂, and Fe²⁺ was fed to a continuously stirred beaker of urea. The parameters and results of each example are shown in FIGS. 7a-7e.

The bar chart at the bottom of FIG. 7e shows a comparison of the oxidation of urea following the process steps of the present disclosure, as indicated with (G-2 through G-5, and following the process steps of the prior art, as indicated with F-2 through F-5. In each G-1 and F-1, comparison data was not generated and therefore are not incorporated in the chart.

As shown in the bar chart at the bottom of FIG. 7e, the controlled process of separately feeding the oxidizer, H₂O₂, and catalyst, Fe²⁺, yields a more complete oxidation of urea than feeding the catalyst and oxidizer together as a Fenton's reagent. In fact, the data shows that feeding a Fentos's reagent fails to result in a decrease of urea in the solution.

Changes in the physical properties exhibited at various points throughout the process of the present disclosure and examples of the prior art further illustrate the advantages obtained by the controlled process of separately feeding the oxidizer, H₂O₂, and catalyst, Fe²⁺ as described in this disclosure. For example, the prior art Fenton's solution is a component containing a pre-mixture of a catalyst Fe²⁺ and hydrogen peroxide. The catalyst was in crystal form having a light green color having generally the following spectra red: 188, green 246, blue 221. The hydrogen peroxide was aqueous and generally exhibited a transparent color. When the catalyst and hydrogen peroxide were mixed together in water to form the Fenton's reagent component, the color of the Fenton's reagent component quickly changed to an orange brown color having generally the following spectra red: 168, green 60, blue 12. In addition, the reaction of the catalyst and hydrogen peroxide produced a bubbling of a gas for a period of time until the bubbles disappeared. When the orange brown Fenton's reagent component was added to the urea, the color of the mixture very quickly turned to a yellowish color having generally the following spectra red: 186, green 219, blue: 129 after which the color did not appear to change.

In contrast, Applicant's oxidizer, H₂O₂, and catalyst, Fe²⁺, in aqueous form, were transparent in color prior to mixing with the urea solution. When oxidizer, H₂O₂, and catalyst, Fe²⁺ in aqueous form were separately fed to the urea solution, that is to say, they were not fed to the urea solution as a single component as done with Fenton's, the resulting mixture slowly changed from a transparent color to a light yellowish color having generally the following spectra: red: 211, green: 236, blue: 147.

The foregoing described bubbling of gases in the Fenton's reagent component illustrates that the Fenton's reagent component is pre-reacting prior to mixing into the urea solution and the mixing of this pre-reacted Fenton's reagent component with the urea solution creates an aggressive change in physical properties as indicated by the quick change (e.g., in a matter of a few seconds) in color from orange brown to yellow. After that, very little change in color was observed correlating to the no reduction of urea illustrated by the tests in FIG. 7.

In contrast, in the process of this disclosure, the separate feeding of H₂O₂, and catalyst, Fe²⁺ in aqueous form into the urea solution reacts in a different matter because the H₂O₂, and catalyst, Fe²⁺ in aqueous form were fed separately into the urea solution and not pre-mixed into a single component for feeding in a single stream into the urea solution. More specifically, on mixing of the separately fed H₂O₂, and catalyst, Fe²⁺ in aqueous form into the urea solution according to this disclosure, the color of the resulting mixture changed from transparent to a light yellowish color in a gradual manner over the life of the experiment. This indicates that the separate feeding of H₂O₂, and catalyst, Fe²⁺ in aqueous form into the urea solution according to this disclosure provides a controlled reduction of urea from the solution as illustrated in FIG. 7.

### INDUSTRIAL APPLICABILITY

As apparent from the above description, the process and system for removing urea from an aqueous solution in accordance with the present invention decreases the amount of time required to oxidize the urea in an aqueous solution with hydrogen peroxide. The presently disclosed process and system may be add to or incorporated with existing processes and systems for treating aqueous solutions. Such incorporation or addition may increase the performance and/or capabilities of the existing processes and systems.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

What is claimed is:

1. A process for removing urea from an aqueous solution comprising the steps of:
(a) feeding an aqueous solution comprising urea into a mix tank;
(b) feeding hydrogen peroxide into the mix tank;
(c) feeding at least one soluble catalyst into the mix tank separately from the hydrogen peroxide feed;
(d) mixing the aqueous solution comprising urea, hydrogen peroxide, and the at least one soluble catalyst in the mix tank, forming a reactant mixture; and
(e) oxidizing the urea in the reactant mixture yielding CO₂, N₂, and H₂O;
wherein the soluble catalyst is selected from a group of catalysts that when mixed with the hydrogen peroxide and urea causes the rate of reaction of the oxidation of the urea by hydrogen peroxide to accelerate; and
wherein the step of separately feeding at least one soluble catalyst into the mix tank provides a controlled acceleration of oxidation of the urea, at a controlled oxidation reaction constant greater than an oxidation reaction constant of urea with hydrogen peroxide alone.

2. The process of claim 1 wherein the soluble catalyst comprises a soluble iron salt.

3. The process of claim 2 wherein the soluble iron salt is selected from the group consisting of FeSO₄: ferrous sulfate; FeCl₂: Ferrous chloride; Fe(NO₃)₃: Ferric nitrate; Fe(SO₄)₃: Ferric sulfate; and FeCl₃: Ferric chloride.

4. The process of claim 2 wherein the soluble iron salt is C₁₂H₂₂FeO₁₄.

5. The process of claim 1 further comprising a step of feeding one or more oxidizing agents into the mix tank, wherein the one or more oxidizing agents are fed in an amount to decelerate the overall rate of oxidation of the urea by a controlled amount.

6. The process of claim 5 wherein the steps of feeding hydrogen peroxide into the mix tank, feeding at least one soluble catalyst into the mix tank, and feeding one or more oxidizing agents into the mix tank provide the reactant mixture, in the mix tank, with an oxidation reaction constant of urea greater than an oxidation reaction constant of urea with hydrogen peroxide alone.

7. The process of claim 5 wherein the one or more oxidizing agents is selected from the group consisting of sodium chloride, potassium iodine, potassium bromide, manganese, and combinations thereof.

8. The process of claim 7 wherein the one or more oxidizing agents comprise a sodium chloride, a potassium iodine, a potassium bromide, and manganese.

9. The process of claim 8 wherein the one or more oxidizing agents are fed into the mix tank at a rate to provide a concentration of each of the sodium chloride, the potassium iodine, the potassium bromide, and the manganese at about 10 parts per million in the reactant mixture.

10. The process of claim 1 wherein the step of oxidizing the urea in the reactant mixture is performed for up to about 30 minutes.

11. The process of claim 1 wherein the step of oxidizing the urea in the reactant mixture comprises oxidizing at least about 90% of the urea in the aqueous solution comprising urea.

12. The process of claim 1 wherein the step of oxidizing the urea in the reactant mixture is primarily performed in a reactor, wherein the reactor is a holding tank, a settling tank, or a pipe, the reactor being configured to provide a residence time of the reactant mixture flowing therethrough of up to about 30 minutes.

13. The process of claim 12 wherein the reactor has a rough inner surface configured to increase contact between the urea, hydrogen peroxide, and the at least one catalyst in the reactant mixture flowing therethrough.

14. The process of claim 1 wherein the step of feeding hydrogen peroxide into the mix tank comprises feeding about 1.72 grams of hydrogen peroxide for each gram of urea fed into the mix tank during the step of feeding an aqueous solution comprising urea into a mix tank.

15. The process of claim 1 wherein the step of feeding at least one catalyst into the mix tank comprises feeding an amount of catalyst to provide a concentration of catalyst of about 10 ppm in the reactant mixture.

16. The process of claim 1 further comprising the step of:
flowing the reactant mixture through a packed column.

17. The process of claim 16 wherein the step of flowing the reactant mixture through a packed column comprises flowing the reactant mixture through at least one of Berl saddles, Raschig rings, Pall rings, metal Michael Bialecki rings, and ceramic Intalox saddles.

18. The process of claim 1 wherein the at least one catalyst is in solution and the step of feeding at least one catalyst into the mix tank comprises feeding at least one catalyst into the mix tank drop-wise.

19. The process of claim 1 wherein the step of feeding at least one catalyst into the mix tank comprises feeding an amount of catalyst to provide a concentration of catalyst of at most 20 ppm in the reactant mixture.

20. The process of claim 1 wherein the steps of feeding hydrogen peroxide into the mix tank and separately feeding at least one soluble catalyst into the mix tank comprise feeding 1 to 2 grams per second of the at least one soluble catalyst for each gram per second of the hydrogen peroxide being fed into the mix tank.
